(19) United States
(12) Patent Application Publication
(10) Pub. No.: US 2026/0337036 A1
(43) Pub. Date: Oct. 29, 2026

(54) Method for separating and purifying high purity quartz sand from rock series being diorite, quartz diorite, granodiorite and granite

(71) Applicant: LONGYOU YOUJING QUARTZ TECHNOLOG CO., LTD., Quzhou (CN)

(72) Inventors: Jun YANG, Quzhou (CN); CHONG KIN NGAI, Quzhou (CN)

(73) Assignee: LONGYOU YOUJING QUARTZ TECHNOLOG CO., LTD., Quzhou (CN)

(21) Appl. No.: 19/382,600

(22) Filed: Nov. 7, 2025

(30) Foreign Application Priority Data
Apr. 25, 2025 (CN) 2025105321859

(51) Int. Cl. C01B 33/18; B02C 23/16; B03D 1/08

(52) U.S. Cl. CPC C01B 33/18; B02C 23/16; B03D 1/08; C01P 2006/80

(57) ABSTRACT

A method for separating and purifying high-purity quartz sand from rock series being diorite, quartz diorite, granodiorite and granite, comprising: S1: crushing, grinding and filtering samples of magmatics; S2: conducting magnetic separation of different grades on the samples; S3: conducting continuous reverse flotation on the coarse sands for a plurality of times; S4: scrubbing the quartz sand ores; S5: regrinding, filtering and dressing scrubbed quartz sand ores by magnetic separation of different grades; S6: dressing the fine quartz sands by continuous reverse flotation for a plurality of times.

### CROSS-REFERENCE

This application claims the benefit of priority from China Patent Application No. CN 2025105321859 filed on Apr. 25, 2025, the contents of which are hereby incorporated by reference in their entirety.

### TECHNICAL FIELD

The present invention belongs to the technical field of quartz sand separation and extraction, specifically a method for extracting and purifying high purity quartz sand from rock series being diorite, quartz diorite, granodiorite and granite.

### BACKGROUND TECHNOLOGY

High-purity quartz sands are core raw materials for strategic industries such as photovoltaic crucible, semiconductor crucibles or optical fibers;
Conventional quartz sand extraction and purification processes are: crude ore crushing→calcination and water quenching→grinding→magnetic separation→floatation→acid dipping→high temperature chlorination→finishing; the present method is highly dependent on the ore resources: it is usable only for high quality veined quartz or granitic pegmatites, due to limitations of the mineralogy and deficiencies of the flotation separation techniques, this method cannot be used for separation of magmatics such as diorite, quartz diorite, granodiorite and granite; Globally, there are vast reserves of magmatic rocks (e.g., diorite, quartz diorite, granodiorite, and granite). However, high-quality veined quartz or granitic pegmatites constitute only a limited proportion. Consequently, existing production technologies and methods for high-purity quartz sands continue to face supply bottlenecks.

Mineralogical limitations: In diorite, quartz diorite, granodiorite, and granite, quartz-feldspar-mica present an interlaced structure. Quartz usually crystallizes at last and is filled in the gaps of the early-crystallized minerals. Moreover, the crystalline particles are relatively fine, making it difficult to achieve monomer dissociation through mechanical crushing and color separation.

Deficiencies of flotation separation techniques: floating agents work relatively simply on separation and removal of foreign matters in veined quartz and granitic pegmatites; however, they don't work well on separation of complex mineral mixtures such as diorite, quartz diorite, granodiorite and granite, as there are a lot of foreign minerals such as feldspar, quartz and mica, separation of which involves complex processes and economic separation and purification thereof is not easy.

### SUMMARY OF THE INVENTION

The present invention aims to provide a method for separating and purifying high-quality quartz sands from rock series being diorite, quartz diorite, granodiorite and granites to address the technical problem that with conventional quartz separation and purification processes, it is difficult to extract foreign matters in magmatics having huge reserves and separate and purify quartz sands economically, and consequently, lead to supply of high-quality quartz glass domestic and abroad not sufficient.

To realize the foregoing purpose, the present invention provides the following technical solutions:

A method for separating and purifying quartz sands from rock series being diorite, quartz diorite, granodiorite and granites, comprising:
S1: crushing, grinding and filtering samples of magmatics, a sieve size is 20~80 meshes, and obtaining the samples;
S2: conducting magnetic separation of different grades on the samples to remove magnetic matters, and obtaining coarse sands;
S3: conducting continuous reverse flotation on the coarse sands for a plurality of times, enriching quartz particles and obtaining quartz sand fine ores;
S4: scrubbing the quartz sand fine ores and adjusting a pH value of ore slurry to be 6.5~7.5;
S5: after scrubbing, regrinding, filtering and dressing scrubbed quartz sand fine ores by magnetic separation of different grades and obtaining fine quartz sands of 50~200 meshes;
S6: dressing the fine quartz sands by continuous reverse flotation for a plurality of times and obtaining fine quartz ores;
S7: scrubbing the fine quartz ores, washing until the ore slurry has a pH value of 6.5~7.5, and dewatering;
S8: acid dipping dewatered fine quartz ores in mixed acids and obtaining quartz sands;
S9: washing the quartz sands using water, adjusting ore slurry to have a pH value of 6.5~7.5 and dewatering and calcining the quartz sands;
S10: conducting high temperature chlorination for the quartz sands after dewatering and calcining;
S11: collecting and packing the quartz sands after high temperature chlorination and obtaining final high purity quartz sand products.

Preferably, the magmatics comprise any of diorite, quartz diorite, granodiorite and granites.

Preferably, the flotation agents used for continuous reverse flotation comprise ore slurry regulators and collectors of foreign minerals other than quartz, wherein the ore slurry regulators comprise sulfuric acids, hydrofluoric acids and sodium hydroxide and the collectors comprise dodecylamine hydrochloride and sodium oleate.

Preferably, processes for conducting continuous reverse flotation for the coarse sands in the step S3 comprise:
mixing the coarse sands with plasma water at a solid-to-liquid ratio of 1:2 and forming even ore slurry;
adding sulfuric acids and hydrofluoric acids to the ore slurry, a ratio between the sulfuric acids and the hydrofluoric acids is 1:1, adjusting a pH value of the ore slurry to be 2~3, adding dodecylamine hydrochloride and floating foreign minerals out; adding hydrofluoric acids into the ore slurry, adjusting the ore slurry to have a pH value of 3~4, adding dodecylamine hydrochloride and floating the foreign minerals out.

Preferably, processes for conducting continuous reverse flotation for the fine quartz sands in the step S6 comprise:
mixing the fine quartz sands and the plasma water at a solid-to-liquid ratio of 1:2 and forming even slurry;
adding sulfuric acids and hydrofluoric acids to the ore slurry, where a ratio between the sulfuric acids and hydrofluoric acids is 1:1, adjusting a pH value of the ore slurry to be 2~4, adding the dodecylamine hydrochloride and floating the foreign minerals out;
adding hydrofluoric acids to the ore slurry, adjusting the pH value of the ore slurry to be 4~5 and adding the dodecylamine hydrochloride and floating the foreign minerals out;
adding sodium hydroxide to the ore slurry, adjusting the pH value of the ore slurry to be 9~11 and adding sodium oleate and floating the foreign minerals out;
adding the sodium hydroxide to the ore slurry, adjusting the pH value of the ore slurry to be 12~14, adding the sodium oleate and floating the foreign minerals out. Preferably, magnetic separation of different grades comprise three gradient magnetic separation, a first grade 0.5~1.0 T for removing strong magnetic foreign minerals; a second grade 1.0~1.5 T for removing medium magnetic foreign minerals and a third grade 1.5~2.0 T for removing weak magnetic foreign minerals.

Preferably, in the step S8 parameters for acid dipping using mixed acids comprises time 10~20 hours, and temperature 50~100 °C;
Wherein the mixed acids comprise hydrochloric acids having a concentration of 10%-15% and hydrofluoric acids having a concentration of 5%-8% at a volume ratio of 3:1 and a liquid to solid ratio is controlled to be 1:2~3:1.

Preferably, parameters for high temperature chlorination in the step S10 comprises: aerating dry HCl air having a purity equal or over 99% at a nitrogen protected atmosphere, a filling flow rate is 0.5 L~5 L/min, a sample heating temperature 1100~1200 °C and time 60~120 min.

Compared with the prior art, the beneficial effects of the present invention comprise: In the present invention, by repeated continuous flotation, while energy consumption is reduced, an individual quartz dissociation rate is significantly improved, by acid cleaning, high temperature chlorination and magnetic separation, purity of quartz raw materials is highly improved, and a quartz sand purity and contents of micro fluid inclusions satisfy requirements for making quartz glass by melting in optical fiber, semiconductor, photovoltaic and special industries, in this way, high purity quartz sands are separated and extracted from the magmatics having huge reserves, raw material expenses are reduced to a great deal, and a range of raw materials for high purity quartz sands is increased.

### BRIEF DESCRIPTION OF DRAWINGS

To explain the technical solutions in the present invention more clearly, hereinafter a simple introduction will be given to the drawings to be used in the description of the embodiments, apparently, the drawings given here are only some embodiments of the present invention rather than all, for those of ordinary skill in the art, without paying creative effort, it is possible to obtain other drawings based on these drawings. Wherein:

FIG. 1 is a stepwise block diagram showing a method according to the present invention; and

FIG. 2 is a flowchart diagram showing a process according to the present invention.

### EMBODIMENTS

To make the purpose, features and advantages of the present invention more apparent and understood, hereinafter a detailed description on the embodiments of the present invention will be given in conjunction with the drawings.

In the following description, a lot of details are given to help understand the present invention, however, the present invention can be implemented in other ways different from those described here, those skilled in the art can make equivalent replacement without departing from the essence of the present invention, therefore, the present invention is not limited by the embodiments disclosed herein.

Secondly, “an embodiment” or “embodiments” used here are to explain specific features, structures and characters of at least one embodiment of the present invention. The term “in an embodiment” appeared in different portions of the present invention does not intend to refer to the same embodiment and is not an embodiment alone and rejecting other embodiments.

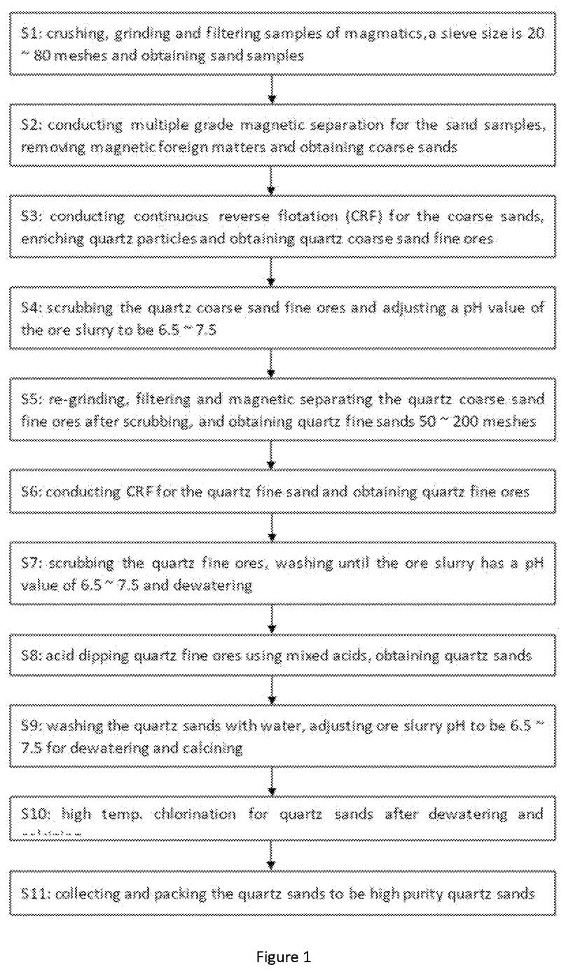

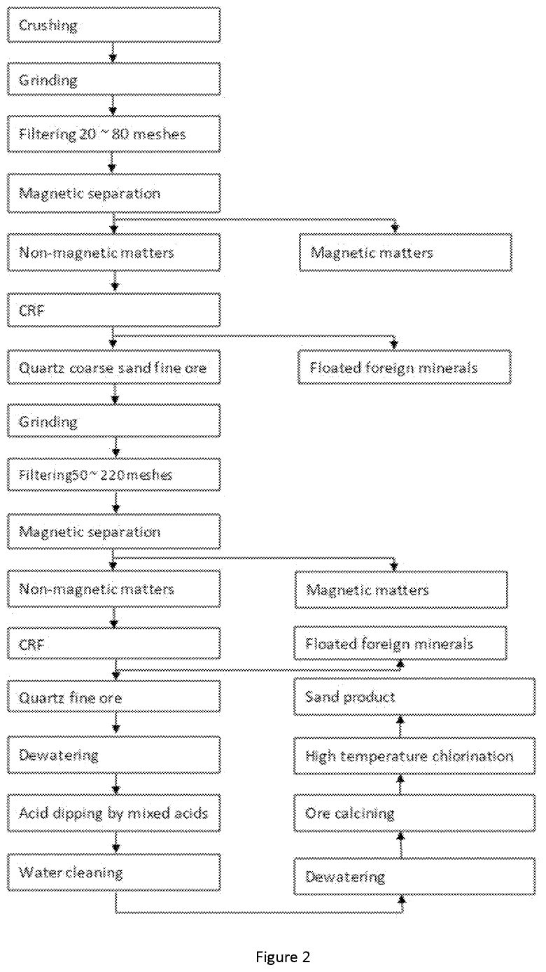

As shown in FIGS. 1-2:

Embodiment one: the present embodiment provides a method for separating and purifying high purity quartz sands from rock series being diorite, quartz diorite, granodiorite and granites, comprising:
S1: crushing, grinding and filtering samples of granodiorites, wherein a filter size is 20~80 meshes, and obtaining the samples;
By mechanical crushing and grinding, original ore structures are broken, quartz can be preliminarily separated from other minerals (feldspar and mica etc.); and by controlling the filter size, efficiency of subsequent flotation and magnetic separation can be promised.
S2: conducting multiple grade magnetic separation for the samples, removing magnetic foreign matters and obtaining coarse sands;
In this way, interference to the subsequent flotation due to strong magnetic foreign matters can be avoided;
S3: conducting continuous reverse flotation for a plurality of times for the coarse sands, enriching quartz particles and obtaining coarse quartz fine ores;
Foreign matters other than quartz can be selectively separated by using the flotation agents and the foreign matters comprise feldspar, mica and ferriferous minerals.
S4: scrubbing the coarse quartz fine ores, and adjusting a pH value of ore slurry to be 7;
By mechanical scrubbing, fine-grained foreign matters and flotation agent residues on surfaces of the quartz can be removed, by setting the pH value to be 7 re-attachment of the foreign matters or another dissolution of the quartz in acid-base environments is avoided, for scrubbing devices, mechanical scrubbers can be used, by high speed revolution of the vanes at 400~500 rpm, a shear force is generated, foreign matter removal is reinforced, surface cleanness of the quartz is improved and condition is created for deep purification.
S5: re-grinding, filtering and conducting multiple grade magnetic separation for the coarse quartz fine ore after scrubbing, and obtaining 50~200 meshes fine quartz sands;
Refining the quartz particles to a further extent, improving individual quartz dissociation, promoting exposing of inclusion foreign matters and releasing foreign matters in micro gaps; by controlling the grain sizes of the quartz, removing the magnetic particles introduced due to mechanical iron pollution during magnetic separation and grinding, until 20~80 meshes and re-grinding, the efficiency is improved significantly.
S6: conducting continuous reverse flotation for a plurality of times for the fine quartz sands and obtaining fine quartz ores;
By pH control in different grades, well-targeted removal of tiny amount foreign matters can be done, including residual feldspar, iron films and ions attached on the surfaces and purity of the quartz can be improved to a large deal.
S7: scrubbing the fine quartz ores, and dewatering after a pH value of the ore slurry is 7;
By removing residues of flotation agents, neutralizing residual acids and bases, washing the ore slurry the pH value of the ore slurry is 7, violent reaction during acid dipping can be prevented, by subsequent dewatering, acid dipping agents consumption in the subsequent acid dipping can be reduced and reaction efficiency can be improved.
S8: acid dipping the fine quartz ores after dewatering using mixed acids and obtaining quartz sands;
In this way, tiny amount foreign matters (Al, Li, B etc.) and surface inclusions at edges of quartz crystal lattices can be dissolved.
S9: washing the quartz sands using water, adjusting the pH value of the ore slurry to be 7, dewatering and calcining;
By removing the acid dipping residues, corrosion on the devices or influences on chlorination reactions of residual acids can be prevented, and by removing absorbed water, generation of corrosive gases due to reaction between vapor and HCl during high temperature chlorination can be prevented.
S10: conducting high temperature chlorination for the quartz sands after dewatering and calcining;
By the gas-solid reaction, the gas-liquid inclusions and trace amount metallic foreign matters in the crystal lattices of the quartz can be removed.
S11: collecting the quartz sands after high temperature chlorination treatment and obtaining final high purity quartz sand products.

Specifically, the flotation agents used for continuous reverse flotation comprise an ore slurry regulator and a collector of foreign minerals other than quartz, wherein the ore slurry regulator comprises sulfuric acids, hydrofluoric acids and sodium hydroxide and the collector comprises dodecylamine hydrochloride and sodium oleate.

Specifically, in the step S3 conducting continuous reverse flotation for the coarse sands comprises:
Mixing the coarse sand and plasma water at a solid-to-liquid ratio of 1:2 and forming even ore slurry;
Adding the sulfuric acids and hydrofluoric acids to the ore slurry, wherein a ratio between the sulfuric acids and the hydrofluoric acids is 1:1, adding a pH value of the ore slurry to be 2~3 and adding the dodecylamine hydrochloride, and floating out the foreign matters;
Al³⁺ on the surfaces of the feldspar is dissolved in strong acidic environments, the feldspar becomes active and is absorbed by dodecylamine hydrochloride, edges of the mica are corroded, internal structures thereof are exposed under action of the collector, and as a positive ion collector, the dodecylamine hydrochloride absorbs first surfaces of feldspar and mica having negative charges and floats the same.

Adding hydrofluoric acids into the ore slurry, adjusting the pH value of the ore slurry to be 3~4 and adding the dodecylamine hydrochloride and the foreign matters can be floated out.

By delicate adjustment of acidity, flotation selectivity to the residual ferriferous minerals is reinforced, main silicate foreign matters can be removed in different stages and a recycling rate of the quartz is improved.

Specifically, in the step S6, processes for conducting continuous reverse flotation for a plurality of times for the fine quartz sands comprise:
Mixing the fine quartz sands and plasma water at a solid-to-liquid ratio of 1:2 to be even ore slurry;
Adding sulfuric acids and hydrofluoric acids to the ore slurry, wherein a rate of the sulfuric acids and the hydrofluoric acids is 1:1, adjusting the pH value of the ore slurry to be 2~4 and adding dodecylamine hydrochloride and floating the foreign matters out;
Floating the residual feldspar and ferriferous minerals again.

Adding hydrofluoric acids to the ore slurry, adjusting the pH value of the ore slurry to be 4~5 and adding dodecylamine hydrochloride and floating the foreign matters out;
Adjusting delicately the acidity to remove complex compounds Fe³⁺ on surfaces. Adding sodium hydroxide to the ore slurry, adjusting the pH value of the ore slurry to be 9~11 and adding sodium oleate and floating the foreign matters out;
Activating the sodium oleate in an alkaline environment, floating calcium and magnesium minerals absorbed on the surfaces of the quartz, replacing the dodecylamine hydrochloride with sodium oleate to adapt to electricity changes of the surfaces of the foreign matters in different pHs.

Adding sodium hydroxide to the ore slurry, adjusting the pH value of the ore slurry to be 12~14, adding the sodium oleate and floating the foreign matters out.

Removing ferric oxide films on the surfaces of the quartz by alkaline hydroxylation action.

Specifically, multiple grade magnetic separation comprises three gradient magnetic separation, a first grade 0.5~1.0 T for removing strong magnetic substances; a second grade 1.0~1.5 T removing medium magnetic substances and a third grade 1.5~2.0 T for removing weak magnetic substances.

Specifically, in the step S7 parameters for acid dipping using mixed acids comprise: time 10~20 hours, and temperature 50~100 °C;
Mixed acids comprise hydrochloric acids having a concentration of 10%~15% and hydrofluoric acids having a concentration of 5%~8% at a volume rate of 3:1, and the liquid-to-solid rate is controlled to be 1:2~3:1.

The hydrochloric acids having a concentration of 10%~15% are to dissolve metallic oxides, comprising Fe₂O₃, Al₂O₃, hydrofluoric acids having a concentration of 5%~8% are to corrode silicate foreign matters, open microspheres in surfaces of the quartz, and temperature 50~100 °C accelerates acid reaction dynamics, reduces treatment time, and the liquid-to-solid rate promises that the acid solution immerges the quartz particles sufficiently.

Specifically, in the step S10, high temperature chlorination treatment parameters comprise: filling dry HCl gases having a purity equal or over 99% in a nitrogen shielded atmosphere, an aeration flow rate is 0.5 L~5 L/min, a sample heating temperature is 1100~1200 °C and time 60~120 min.

At the temperature of 1100~1200 °C, a to B phase change temperature of quartz has been reached, the crystal lattices expand and release inclusions, dry HCl gases and foreign metals (such as Fe, Al) generate volatile chloride (FeCl₃↑ and AlCl₃↑) and the aeration flow rate 0.5~5 L/min is configured to balance a reaction rate and a gas utility rate.

Purity data of the granodiorites after purifying using the foregoing method is shown in the following table:

| Al | B | Ba | Ca | Co | Cr | Cu | Fe | Ge | K |
|---|---|---|---|---|---|---|---|---|---|
| 26.93 | 0.80 | 0.15 | 0.86 | 0.00 | 0.00 | 0.00 | 0.63 | 0.63 | 1.37 |
| Li | Mg | Mn | Na | Ni | P | Ti | Zr | Ce | Dy |
| 1.91 | 0.42 | 0.02 | 0.62 | 0.00 | 1.26 | 9.49 | 0.72 | 0.24 | 0.00 |
| Er | Eu | Gd | Hf | Ho | La | Lu | Mo | Nd | Pr |
| 0.00 | 0.00 | 0.01 | 0.02 | 0.00 | 0.13 | 0.00 | 0.00 | 0.10 | 0.03 |
| Sm | Sr | Tb | Th | Tm | U | V | Y | Yb | Zn |
| 0.02 | 0.05 | 0.00 | 0.08 | 0.00 | 0.01 | 0.00 | 0.03 | 0.00 | 0.00 |

| | | Final purity of |
|---|---|---|
| | | high-purity |
| | μg/g | quartz sand |
| Purity data | 46.56 | 99.9953% |

Granularity distribution data of the granodiorites after treatment using the foregoing method are shown in the following table:

Laser granularity analysis Unit: μm
Granularity distribution is as follows:

| D0 | D1 | D5 | D10 | D15 | D25 |
|---|---|---|---|---|---|
| 61 | 92 | 126 | 148 | 166 | 196 |
| D50 | D75 | D90 | D95 | D99 | D100 |
| 260 | 337 | 412 | 473 | 575 | 655 |

| | | | | |
|---|---|---|---|---|
| >375 | 280-375 | 187-280 | 125-187 | Percentage |
| 16.8% | 25.7% | 35.3% | 17.5% | sum |
| 100-125 | 83-100 | 75-83 | <75 | 100% |
| 3.2% | 1.0% | 0.3% | 0.2% | |

In the present invention, by separating and purifying high-purity quartz sands from diorite, quartz diorite, granodiorite and granites (initial quartz contents 5~60%), raw material expenses are reduced greatly, and the scope of raw materials for high-purity quartz sands is expanded;
By continuous flotation for a plurality of times, while energy consumption is reduced, individual quartz dissolution rate can be improved to over 99.95%;
By acid cleaning, high temperature chlorination and magnetic separation, finally the purity of the quartz raw material reaches over 99.995%;
And the purity of the quartz sand product and contents of micro gas-liquid inclusions satisfy requirements for industrial melting and making quartz glass in optic fiber, semiconductor, photovoltaic and special industries.

It is important to note that construction and arrangement of the present invention shown in exemplary embodiments are only exemplary. Although only a few embodiments are described in detail in this disclosure, it should be readily understood by those who refer to this disclosure that many modifications are possible (e.g., the size, scale, structure, shape and proportion of various elements, and parameter values (e.g., temperature, pressure, etc.), mounting arrangements, use of materials, color, changes in orientation, etc.) without substantially departing from the novel teachings and advantages of the subject matter described in the present invention. For example, an element shown as integrally formed may be composed of multiple parts or elements, the position of the element may be inverted or otherwise changed, and the nature or number or position of the discrete element may be altered or changed. Therefore, all such modifications are intended to be included within the scope of the present invention. The order or sequence of any process or method steps may be changed or reordered according to an alternative embodiment. In the claims, any “device plus function” clause is intended to cover the structure described herein that performs the function, and is not only structurally equivalent but also equivalent in structure. Other substitutions, modifications, changes and omissions may be made in the design, operating conditions and arrangement of the exemplary embodiments without departing from the scope of the present invention. Therefore, the present invention is not limited to a specific embodiment, but extends to a variety of modifications that still falls within the scope of the appended claims.

In addition, in order to provide a concise description of the exemplary embodiment, not all features of the actual embodiment (i.e., those features that are not relevant to the best mode currently considered to perform the invention, or those features that are not relevant to the implementation of the invention) may be described.

It should be understood that in the development of any actual embodiment, for example, in any engineering or design project, a large number of specific implementation decisions can be made. Such development efforts may be complex and time-consuming, but for those of ordinary skill who benefit from this disclosure, no excessive experimentation is required, the development efforts will be a routine work of design, manufacturing and production.

It should be noted that the above embodiments are only used to illustrate the technical solutions of the present invention and are not limiting the same. Although the present invention is described in detail with reference to the preferred embodiments, those of ordinary skill in the art should understand that the technical solutions of the present invention can be modified or equivalently replaced without departing from the spirit and scope of the technical solutions of the present invention, which should be covered by the scope of the claims of the present invention.

1. A method for separating and purifying quartz sands from rock series being diorite, quartz diorite, granodiorite and granite, comprising:
S1: crushing, grinding and filtering samples of magmatics, a sieve size is 20~80 meshes, and obtaining the samples;
S2: conducting magnetic separation of different grades on the samples to remove magnetic matters, and obtaining coarse sands;
S3: conducting continuous reverse flotation on the coarse sands for a plurality of times, enriching quartz particles and obtaining quartz sand fine ores;
S4: scrubbing the quartz sand fine ores and adjusting a pH value of ore slurry to be 6.5~7.5;
S5: regrinding, filtering and dressing scrubbed quartz sand fine ores by magnetic separation of different grades and obtaining fine quartz sands of 50~200 meshes;
S6: dressing the fine quartz sands by continuous reverse flotation for a plurality of times and obtaining fine quartz ores;
S7: scrubbing the fine quartz ores, washing until the ore slurry has a pH value of 6.5~7.5, and dewatering;
S8: acid dipping dewatered fine quartz ores in mixed acids and obtaining quartz sands;
S9: washing the quartz sands using water, adjusting ore slurry to have a pH value of 6.5~7.5 and dewatering and calcining the quartz sands;
S10: conducting high temperature chlorination for dewatered quartz sands and calcining;
S11: collecting and packing the quartz sands after high temperature chlorination and obtaining final high purity quartz sand products.

2. The method for separating and purifying quartz sands from rock series being diorite, quartz diorite, granodiorite and granite according to claim 1, wherein the magmatics comprise any of diorite, quartz diorite, granodiorite and granite.

3. The method for separating and purifying quartz sands from rock series being diorite, quartz diorite, granodiorite and granite according to claim 1, wherein the flotation agents used for continuous reverse flotation comprise ore slurry regulators and collectors of foreign minerals other than quartz, wherein the ore slurry regulators comprise sulfuric acids, hydrofluoric acids and sodium hydroxide and the collectors comprise dodecylamine hydrochloride and sodium oleate.

4. The method for separating and purifying quartz sands from rock series being diorite, quartz diorite, granodiorite and granite according to claim 3, wherein processes for conducting continuous reverse flotation for the coarse sands in the step S3 comprise:
mixing the coarse sands with plasma water at a solid-to-liquid ratio of 1:2 and forming even ore slurry;
adding sulfuric acids and hydrofluoric acids to the ore slurry, a ratio between the sulfuric acids and the hydrofluoric acids is 1:1, adjusting a pH value of the ore slurry to be 2~3, adding dodecylamine hydrochloride and floating foreign minerals out;
adding hydrofluoric acid into the ore slurry, adjusting the ore slurry to have a pH value of 3~4, adding dodecylamine hydrochloride and floating the foreign minerals out.

5. The method for separating and purifying quartz sands from rock series being diorite, quartz diorite, granodiorite and granite according to claim 3, wherein processes for conducting continuous reverse flotation for the fine quartz sands in the step S6 comprise:
mixing the fine quartz sands and the plasma water at a solid-to-liquid ratio of 1:2 and forming even slurry;
adding sulfuric acids and hydrofluoric acids to the ore slurry, where a ratio between the sulfuric acids and hydrofluoric acids is 1:1, adjusting a pH value of the ore slurry to be 2~4, adding the dodecylamine hydrochloride and floating the foreign minerals out;
adding hydrofluoric acids to the ore slurry, adjusting the pH value of the ore slurry to be 4~5 and adjusting the dodecylamine hydrochloride and floating the foreign minerals out;
adding sodium hydroxide to the ore slurry, adjusting the pH value of the ore slurry to be 9~11 and adding sodium oleate and floating the foreign minerals out; and
adding the sodium hydroxide to the ore slurry, adjusting the pH value of the ore slurry to be 12~14, adding the sodium oleate and floating the foreign minerals out.

6. The method for separating and purifying quartz sands from rock series being diorite, quartz diorite, granodiorite and granite according to claim 1, wherein magnetic separation of different grades comprise three gradient magnetic separation, a first grade 0.5~1.0 T for removing strong magnetic foreign minerals; a second grade 1.0~1.5 T for removing medium magnetic foreign minerals and a third grade 1.5~2.0 T for removing weak magnetic foreign minerals.

7. The method for separating and purifying quartz sands from rock series being diorite, quartz diorite, granodiorite and granite according to claim 1, wherein in the step S8 parameters for acid dipping using mixed acids comprises time 10~20 hours, and temperature 50~100 °C;
wherein the mixed acids comprise hydrochloric acid having a concentration of 10%-15% and hydrofluoric acid having a concentration of 5%-8% at a volume ratio of 3:1 and a liquid to solid ratio is controlled to be 1:2~3:1.

8. The method for separating and purifying quartz sands from rock series being diorite, quartz diorite, granodiorite and granite according to claim 1, wherein parameters for high temperature chlorination in the step S10 comprises: aerating dry HCL air having a purity equal or over 99% at a nitrogen protected atmosphere, a filling flow rate is 0.5 L~5 L/min, a sample heating temperature 1100~1200 °C and time 60~120 min.
